(19) United States
(12) Patent Application Publication
(10) Pub. No.: US 2026/0299086 A1
(43) Pub. Date: Oct. 1, 2026

(54) OBJECT RECOGNITION APPARATUS, OBJECT RECOGNITION METHOD, AND RECORDING MEDIUM

(71) Applicant: NEC Corporation, Tokyo (JP)

(72) Inventors: Takashi SHIBATA, Tokyo (JP); Masahiro YAMAGUCHI, Tokyo (JP); Toshinori HOSOI, Tokyo (JP); Motoki MASAKA, Tokyo (JP); Sao KOYAMA, Tokyo (JP); Anri SUEYOSHI, Tokyo (JP); Takashi TAKEUCHI, Tokyo (JP)

(73) Assignee: NEC Corporation, Tokyo (JP)

(21) Appl. No.: 19/569,091

(22) Filed: Mar. 17, 2026

(30) Foreign Application Priority Data
Mar. 26, 2025 (JP) 2025-051249

(51) Int. Cl. G01S 7/41; G01S 13/89

(52) U.S. Cl. CPC G01S 7/415; G01S 13/89

(57) ABSTRACT

In an object recognition apparatus, an image generation unit generates a candidate image corresponding to a candidate velocity, based on the candidate velocity equivalent to a velocity obtained by changing an observation velocity of a target observed by a radar device within a predetermined range and a reflected wave signal having a waveform corresponding to a reflected wave generated by reflection of a transmission wave emitted from the radar device by the target. A recognition result output unit outputs a recognition result of the target based on a first identification result of the target included in the candidate image.

### INCORPORATION BY REFERENCE

This application is based upon and claims the benefit of priority from Japanese Patent Application 2025-051249, filed on March 26, 2025, the disclosure of which is incorporated herein in its entirety by reference.

### TECHNICAL FIELD

The present disclosure relates to a technique that can be used to recognize targets observed by radar devices.

### BACKGROUND ART

A technique that can be used to recognize targets observed by radar devices has been proposed.

Specifically, for example, JP2017-003494A discloses a radar device of an inverse synthetic aperture radar (ISAR) type that tracks on both of range and Doppler frequency axes a target acquired from a reception signal of a real aperture antenna, obtains an image center of the target, and performs range compression and azimuth compression (AZ compression) to acquire an image of the target.

### SUMMARY

However, the technology disclosed in JP2017-003494A may decrease recognition accuracy of the target due to an error in velocity used for acquiring the image of the target, for example.

An example object of the present disclosure is to provide an object recognition apparatus capable of securing recognition accuracy of a target observed by a radar device.

According to an aspect of the present disclosure, an object recognition apparatus includes: an image generation means for generating a candidate image corresponding to a candidate velocity, based on the candidate velocity equivalent to a velocity obtained by changing an observation velocity of a target observed by a radar device within a predetermined range and a reflected wave signal having a waveform corresponding to a reflected wave generated by reflection of a transmission wave emitted from the radar device by the target; and a recognition result output means for outputting a recognition result of the target based on a first identification result of the target included in the candidate image.

According to another aspect of the present disclosure, an object recognition method executed by a computer includes: generating a candidate image corresponding to a candidate velocity, based on the candidate velocity equivalent to a velocity obtained by changing an observation velocity of a target observed by a radar device within a predetermined range and a reflected wave signal having a waveform corresponding to a reflected wave generated by reflection of a transmission wave emitted from the radar device by the target; and outputting a recognition result of the target based on a first identification result of the target included in the candidate image.

According to still another aspect of the present disclosure, a recording medium records program for causing a computer to perform processing including: generating a candidate image corresponding to a candidate velocity, based on the candidate velocity equivalent to a velocity obtained by changing an observation velocity of a target observed by a radar device within a predetermined range and a reflected wave signal having a waveform corresponding to a reflected wave generated by reflection of a transmission wave emitted from the radar device by the target; and outputting a recognition result of the target based on a first identification result of the target included in the candidate image.

According to the present disclosure, it is capable of securing recognition accuracy of the target observed by the radar device.

### BRIEF DESCRIPTION OF THE DRAWINGS

FIG. 1 is a diagram illustrating a schematic configuration of an observation system including an information processing device according to the present disclosure;

FIG. 2 is a block diagram illustrating an example of a hardware configuration of the information processing device according to the present disclosure;

FIG. 3 is a block diagram illustrating an example of a functional configuration of a radar device and the information processing device according to the present disclosure;

FIG. 4 is a diagram illustrating an example of a specific configuration of a signal reconstruction unit;

FIG. 5 is a flowchart illustrating an example of processing performed in the information processing device according to the present disclosure;

FIG. 6 is a diagram illustrating an example of a configuration according to a modification example of the present disclosure;

FIG. 7 is a block diagram illustrating an example of a functional configuration of an object recognition apparatus according to the present disclosure; and

FIG. 8 is a flowchart illustrating an example of processing performed in the object recognition apparatus according to the present disclosure.

### EXAMPLE EMBODIMENTS

Hereinafter, preferred example embodiments of the present disclosure will be described with reference to the drawings.

### First Example Embodiment

### System Configuration

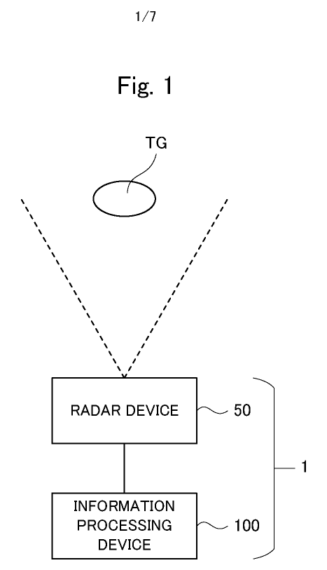

FIG. 1 is a diagram illustrating a schematic configuration of an observation system including an information processing device according to the present disclosure. As illustrated in FIG. 1, an observation system 1 includes a radar device 50 and an information processing device 100.

The radar device 50 has, for example, a configuration similar to that of a radar device of an ISAR type. The radar device 50 also has a configuration capable of emitting transmission waves such as electromagnetic waves from the ground and receiving reflected waves generated by the transmission waves being reflected by a target TG. The target TG can include, for example, an object moving in the sky, such as an aircraft and a drone. The target TG can also include, for example, an object moving in the sea, such as a vessel. The radar device 50 outputs a signal or the like used for recognizing the target TG to the information processing device 100.

The information processing device 100 performs processing related to recognition of the target TG using the signal or the like received from the radar device 50. The information processing device 100 has a function as an object recognition apparatus.

Incidentally, a velocity of the target TG obtained by the radar device 50 or the information processing device 100 is likely to have an error with respect to an actual velocity of the target TG, and this may decrease recognition accuracy of the target TG. The information processing device 100 can secure the recognition accuracy of the target TG observed by the radar device 50 regardless of the presence or absence of an error with respect to the actual velocity of the target TG by performing processing to be described later.

### Hardware Configuration

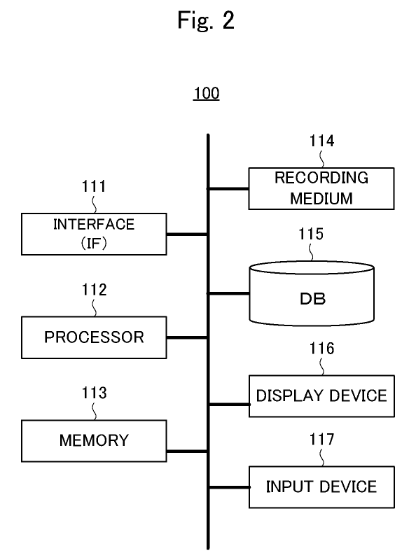

FIG. 2 is a block diagram illustrating an example of a hardware configuration of the information processing device according to the present disclosure. As illustrated in FIG. 2, the information processing device 100 includes an interface (IF) 111, a processor 112, a memory 113, a recording medium 114, a database (DB) 115, a display device 116, and an input device 117.

The IF 111 has a function capable of communicating with an external device. The IF 111 receives, for example, signals output from the radar device 50.

The processor 112 is a computer such as a central processing unit (CPU), and controls an entirety of the information processing device 100 by executing programs prepared in advance. The processor 112 performs, for example, processing related to recognition of the target TG.

The memory 113 includes, for example, a read only memory (ROM) and a random access memory (RAM). The memory 113 is also used as a work memory during execution of various kinds of processing by the processor 112.

The recording medium 114 is a non-volatile, non-transitory recording medium such as a disk-shaped recording medium or a semiconductor memory, and can be attachable to and detachable from the information processing device 100. The recording medium 114 records various programs to be executed by the processor 112. When the information processing device 100 executes various kinds of processing, the programs recorded in the recording medium 114 are loaded into the memory 113 and executed by the processor 112.

The DB 115 stores, for example, processing results obtained by processing of the processor 112.

The display device 116 includes, for example, a liquid crystal display. The display device 116 displays, as necessary, a recognition result of the target TG and the like.

The input device 117 includes, for example, at least one among a keyboard, a mouse, and a touch panel. The input device 117 instructs the processor 112 in accordance with a user's operation.

### Functional Configuration

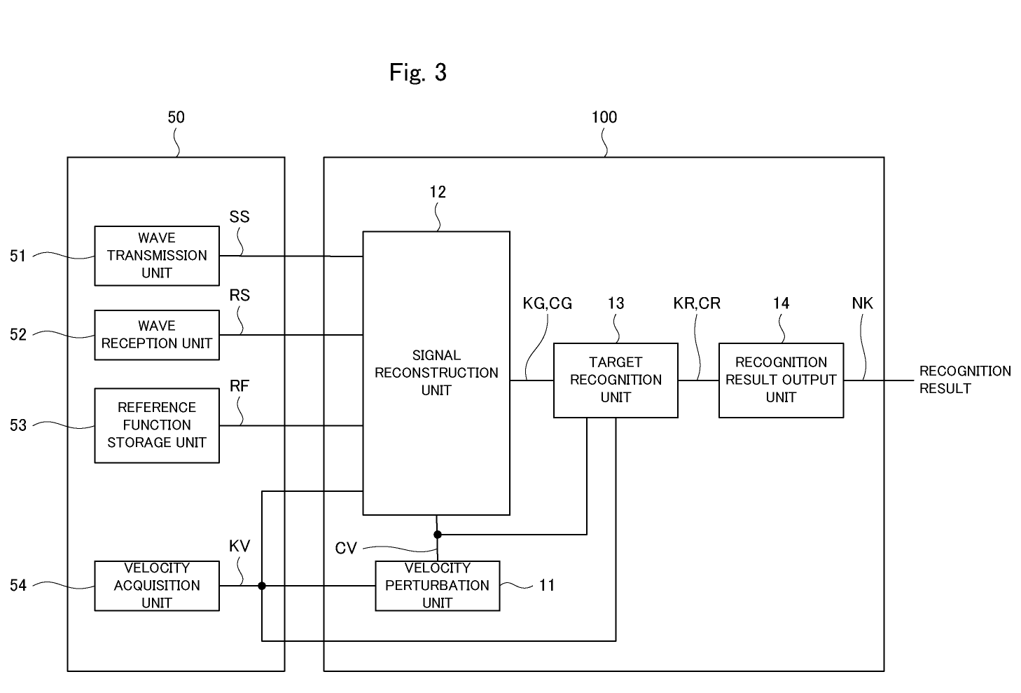

FIG. 3 is a block diagram illustrating an example of a functional configuration of a radar device and the information processing device according to the present disclosure. As illustrated in FIG. 3, the radar device 50 includes a wave transmission unit 51, a wave reception unit 52, a reference function storage unit 53, and a velocity acquisition unit 54.

The wave transmission unit 51 generates a transmission wave SW for observing a target TG, and emits the generated transmission wave SW to a periphery of the radar device 50. The transmission wave SW can include, for example, a radio wave having a chirp waveform. The wave transmission unit 51 generates a transmission wave signal SS having a waveform corresponding to the transmission wave SW, and outputs the generated transmission wave signal SS to the information processing device 100.

The wave reception unit 52 receives a reflected wave RW generated by the transmission wave SW being reflected by the target TG. The wave reception unit 52 generates a reflected wave signal RS having a waveform corresponding to the reflected wave RW, and outputs the generated reflected wave signal RS to the information processing device 100. When generating the reflected wave signal RS from the reflected wave RW, the wave reception unit 52 may perform signal processing such as noise reduction processing on the reflected wave RW as necessary.

The reference function storage unit 53 stores a reference function RF equivalent to a function expressing the process from emission of the transmission wave SW to reception of the transmission wave SW as the reflected wave RW. The reference function RF can include, for example, a transfer function such as a Green’s function. The reference function RF can also include, for example, a range reference function RF1 used for compression processing in a range direction and an azimuth reference function RF2 used for compression processing in an azimuth direction. The reference function RF is, for example, output to the information processing device 100 at any timing after a start of the transmission wave SW emission.

The velocity acquisition unit 54 acquires the velocity of the target TG observed by the radar device 50 as an observation velocity KV, and outputs the acquired observation velocity KV to the information processing device 100. The observation velocity KV includes, for example, a center-of-gravity velocity GV and a rotating velocity RV of the target TG. The observation velocity KV can include, for example, at least one of velocities calculated based on a Doppler shift of the transmission wave SW and the reflected wave RW and received from the target TG.

In the present disclosure, at least a part of the functions of the velocity acquisition unit 54 may be provided in the information processing device 100. Specifically, for example, the radar device 50 may have the function of calculating the observation velocity KV based on the Doppler shift of the transmission wave SW and the reflected wave RW, and the information processing device 100 may have the function of receiving the observation velocity KV from the target TG. Hereinafter, unless otherwise specified, it is assumed that one of the velocities calculated based on the Doppler shift of the transmission wave SW and the reflected wave RW or received from the target TG is acquired as the observation velocity KV.

As illustrated in FIG. 3, the information processing device 100 includes a velocity perturbation unit 11, a signal reconstruction unit 12, a target recognition unit 13, and a recognition result output unit 14.

The velocity perturbation unit 11 has a function as a velocity perturbation means. The velocity perturbation unit 11 generates a candidate velocity CV by changing the observation velocity KV obtained from the radar device 50 within a predetermined range, and outputs the generated candidate velocity CV to the signal reconstruction unit 12 and the target recognition unit 13. For example, when the center-of-gravity velocity GV and the rotating velocity RV are included in the observation velocity KV, the velocity perturbation unit 11 can generate the candidate velocity CV including a velocity GV1 obtained by changing the center-of-gravity velocity GV within a predetermined range and a velocity RV1 obtained by changing the rotating velocity RV within the predetermined range. The velocity perturbation unit 11 is only required to generate at least one velocity different from the observation velocity KV as the candidate velocity CV by changing the observation velocity KV within a predetermined range.

The signal reconstruction unit 12 has a function of an image generation means. The signal reconstruction unit 12 generates an observation image KG corresponding to the observation velocity KV obtained from the radar device 50 and a candidate image CG corresponding to the candidate velocity CV obtained from the velocity perturbation unit 11, based on the transmission wave signal SS, the reflected wave signal RS, and the reference function RF obtained from the radar device 50. The signal reconstruction unit 12 also outputs the observation image KG and the candidate image CG to the target recognition unit 13. When acquiring multiple candidate velocities CV from the velocity perturbation unit 11, the signal reconstruction unit 12 can generate multiple candidate images CG corresponding to each of multiple candidate velocities CV and output the generated multiple candidate images CG to the target recognition unit 13. In the present disclosure, for example, a “signal reconstruction unit” can be rephrased as an “image generation unit”.

The target recognition unit 13 has a function as a target recognition means. The target recognition unit 13 acquires an identification result KR of the target TG included in the observation image KG, based on the observation velocity KV obtained from the radar device 50 and the observation image KG obtained from the signal reconstruction unit 12, and outputs the acquired identification result KR to the recognition result output unit 14.

The target recognition unit 13 acquires an identification result CR of the target TG included in the candidate image CG based on the candidate velocity CV obtained from the velocity perturbation unit 11 and the candidate image CG obtained from the signal reconstruction unit 12, and outputs the acquired identification result CR to the recognition result output unit 14. For example, in a case where n (2 ≤ n) candidate velocities CV are acquired from the velocity perturbation unit 11 and n candidate images CG are acquired from the signal reconstruction unit 12, the target recognition unit 13 can acquire n identification results CR by performing processing for each group of candidate velocity CV and candidate image CG having a correspondence relationship with each other.

The recognition result output unit 14 has a function as a recognition result output means. The recognition result output unit 14 acquires a class of the target TG based on the identification result KR and the identification result CR obtained from the target recognition unit 13, and outputs information including the acquired class of the target TG as a recognition result NK of the target TG. The recognition result NK may be stored in the DB 115 or may be displayed on the display device 116, for example.

### Specific Example

Next, a specific example of processing performed in the present disclosure will be described.

The velocity perturbation unit 11 generates the candidate velocity CV by changing the observation velocity KV within a predetermined range, and outputs the generated candidate velocity CV to the signal reconstruction unit 12 and the target recognition unit 13.

For example, the velocity perturbation unit 11 sets the observation velocity KV as a reference value and changes the observation velocity KV by 1% within a range from -10% to +10% of the set reference value, thereby generating 20 candidate velocities CVs different from the observation velocity KV. Alternatively, the velocity perturbation unit 11 can, for example, set a Gaussian distribution having the observation velocity KV as a median value and select at least one velocity from among the velocities belonging to a predetermined standard deviation range in the Gaussian distribution, thereby generating a candidate velocity CV different from the observation velocity KV.

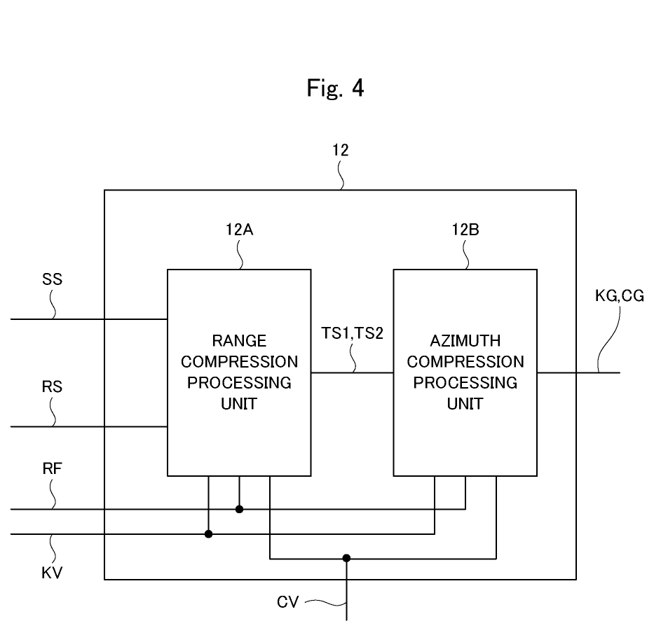

FIG. 4 is a diagram illustrating an example of a specific configuration of a signal reconstruction unit. As illustrated in FIG. 4, the signal reconstruction unit 12 includes a range compression processing unit 12A and an azimuth compression processing unit 12B, for example.

The range compression processing unit 12A performs range compression processing on the reflected wave signal RS using the transmission wave signal SS, the observation velocity KV, and the range reference function RF1 included in the reference function RF, thereby generating an output signal TS1 corresponding to the observation velocity KV. The range compression processing unit 12A also performs the range compression processing on the reflected wave signal RS using the transmission wave signal SS, the candidate velocity CV, and the range reference function RF1 included in the reference function RF, thereby generating an output signal TS2 corresponding to the candidate velocity CV. The range compression processing unit 12A outputs the output signal TS1 and the output signal TS2 to the azimuth compression processing unit 12B.

The azimuth compression processing unit 12B performs azimuth compression processing on the output signal TS1 using the observation velocity KV and the azimuth reference function RF2 included in the reference function RF, thereby generating an observation image KG corresponding to the observation velocity KV. The azimuth compression processing unit 12B also performs the azimuth compression processing on the output signal TS2 using the candidate velocity CV and the azimuth reference function RF2 included in the reference function RF, thereby generating a candidate image CG corresponding to the candidate velocity CV. The azimuth compression processing unit 12B outputs the observation image KG and the candidate image CG to the target recognition unit 13.

The signal reconstruction unit 12 is not limited to one having the configuration as illustrated in FIG. 4. The signal reconstruction unit 12 may be configured using, for example, a neural network such as a convolutional neural network (CNN).

The target recognition unit 13 is configured as, for example, a learned machine learning model LM having a neural network, such as ResNet. The machine learning model LM may be constructed as a learned model by supervised learning, for example.

The target recognition unit 13 acquires the identification result KR of a shape of the target TG included in the observation image KG by inputting the observation velocity KV and the observation image KG into the machine learning model LM, and outputs the acquired identification result KR to the recognition result output unit 14. The identification result KR can include, for example, at least one probability value indicating an object type to which the shape of the target TG included in the observation image KG belongs.

The target recognition unit 13 acquires the identification result CR of the shape of the target TG included in the candidate image CG by inputting the candidate velocity CV and the candidate image CG into the machine learning model LM, and outputs the acquired identification result CR to the recognition result output unit 14. The identification result CR can include, for example, at least one probability value indicating an object type to which the shape of the target TG included in the candidate image CG belongs. For example, in a case where n candidate velocities CV are acquired from the velocity perturbation unit 11 and n candidate images CG are acquired from the signal reconstruction unit 12, the target recognition unit 13 can acquire n identification results CR by sequentially inputting, into the machine learning model LM, the groups of the candidate velocity CV and the candidate image CG having a correspondence relationship with each other.

For example, the target recognition unit 13 may obtain an identification result of the shape of the target TG by inputting, to the machine learning model LM, data to which a velocity is added as a label of an image. Alternatively, the target recognition unit 13 may obtain an identification result of the shape of the target TG by inputting a velocity and an image to a cross attention layer of the machine learning model LM, for example.

The recognition result output unit 14 acquires a class of the target TG based on the identification result KR and the identification result CR obtained from the target recognition unit 13, and outputs information including the acquired class of the target TG as a recognition result NK of the target TG.

The recognition result output unit 14 can acquire, for example, an object corresponding to the highest probability value of the probability value included in the identification result KR and the probability values included in the one or more identification results CR as the class of the target TG. The class of the target TG can include, for example, information indicating a category of the target TG, such as an aircraft and a drone. The class of the target TG can also include, for example, information indicating a specific name of the target TG, such as a model of an aircraft.

### Processing Flow

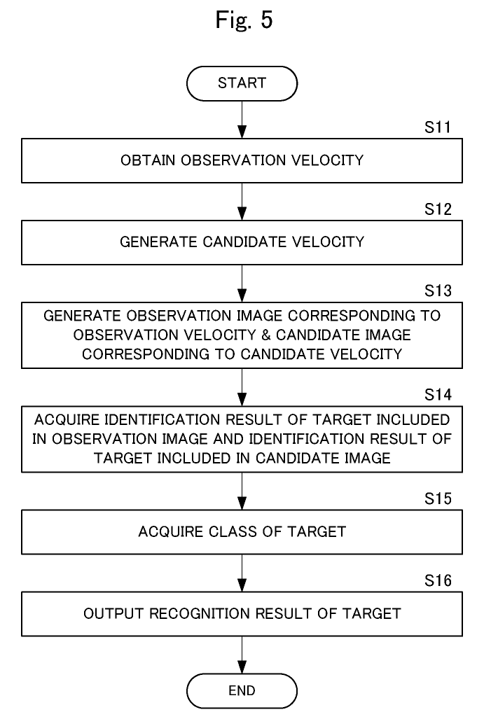

Next, a flow of processing performed in the information processing device 100 will be described. FIG. 5 is a flowchart illustrating an example of processing performed in the information processing device according to the present disclosure.

First, the information processing device 100 acquires an observation velocity KV from the radar device 50 (step S11), and generates a candidate velocity CV by changing the acquired observation velocity KV within a predetermined range (step S12). The candidate velocity CV is only required to be generated as at least one velocity different from the observation velocity KV.

Next, the information processing device 100 generates an observation image KG corresponding to the observation velocity KV and a candidate image CG corresponding to the candidate velocity CV, using a reference function RF, a reflected wave signal RS, and the like acquired from the radar device 50 (step S13).

Next, the information processing device 100 acquires an identification result KR of a target TG included in the observation image KG, based on the observation velocity KV and the observation image KG (step S14). The information processing device 100 also acquires an identification result CR of the target TG included in the candidate image CG, based on the candidate velocity CV and the candidate image CG (step S14).

Next, the information processing device 100 acquires a class of the target TG based on the identification result KR and the identification result CR (step S15), and outputs information including the acquired class of the target TG as a recognition result NK of the target TG (step S16).

As described above, the present example embodiment is capable of generating the observation image KG corresponding to the observation velocity KV and the candidate image CG corresponding to the candidate velocity CV different from the observation velocity KV. The present example embodiment is also capable of acquiring the recognition result NK of the target TG based on the identification result of the target TG obtained by processing using the observation velocity KV and the observation image KG and the identification result of the target TG obtained by processing using the candidate velocity CV and the candidate image CG. The present example embodiment is therefore capable of securing the recognition accuracy of the target TG regardless of the presence or absence of an error with respect to the actual velocity of the target TG.

### Modification Examples

Hereinafter, modification examples of the present example embodiment will be described. In the following description, detailed description regarding portions to which the previously described processing or the like can be applied will be omitted as appropriate for the sake of simplicity.

### First Modification Example

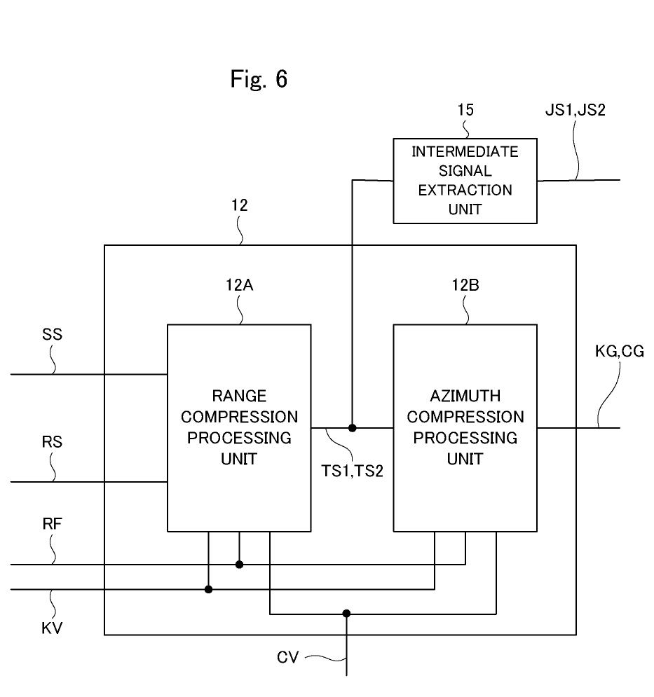

FIG. 6 is a diagram illustrating an example of a configuration according to a modification example of the present disclosure. The information processing device 100 may include an intermediate signal extraction unit 15 as illustrated in FIG. 6.

The intermediate signal extraction unit 15 extracts an intermediate signal indicating an intermediate output in the process of generating the observation image KG from the reflected wave signal RS by the signal reconstruction unit 12. The intermediate signal extraction unit 15 also extracts an intermediate signal indicating an intermediate output in the process of generating the candidate image CG from the reflected wave signal RS by the signal reconstruction unit 12.

For example, in a case where the signal reconstruction unit 12 has a configuration as illustrated in FIG. 4, the intermediate signal extraction unit 15 is only required to be provided between an output side of the range compression processing unit 12A and an input side of the target recognition unit 13. With such a configuration, the intermediate signal extraction unit 15 can extract an output signal TS1 and an output signal TS2 output from the range compression processing unit 12A as intermediate signals.

The intermediate signal extraction unit 15 performs enhancement processing of enhancing an important portion of the output signal TS1 extracted from the range compression processing unit 12A and noise reduction processing of reducing noise included in the output signal TS1. The intermediate signal extraction unit 15 also performs enhancement processing of enhancing an important portion of the output signal TS2 extracted from the range compression processing unit 12A and noise reduction processing of reducing noise included in the output signal TS2. The important portion described above may be rephrased as, for example, information emphasized against noise and unnecessary information for identifying or analyzing objects.

The important portion described above can include information indicating frequency bands, amplitudes, phases, and/or temporal feature portions useful for a particular purpose, for example, identifying and locating objects. The important portion described above can also include, for example, a frequency band available for identification of drones. Specifically, the important portion described above can include a frequency band indicating a reflection characteristic specific to drones, such as a 2.4 GHz band. The important portion described above can also include information indicating frequency bands, amplitudes, phases, and/or temporal feature portions useful in vessel identification and sensing of various targets.

The enhancement processing described above can include, for example, processing of increasing signal intensity of a frequency band FB included in the output signal TS1 and the output signal TS2. The frequency band FB can be set as, for example, a frequency band desired by a user. The frequency band FB can also be set as, for example, a predetermined frequency band in accordance with the transmission wave signal SS. The frequency band FB can also be set as, for example, a variable frequency band that changes according to a type, position, and/or trajectory of the target TG. The enhancement processing and the noise reduction processing described above can be performed using, for example, a model including a neural network such as an auto encoder.

The intermediate signal extraction unit 15 outputs, to the target recognition unit 13, a signal obtained by performing the enhancement processing and noise reduction processing described above on the output signal TS1 as an output signal JS1. The target recognition unit 13 acquires the identification result KR of the target TG included in the observation image KG, based on the observation velocity KV, the observation image KG, and output signal JS1.

The intermediate signal extraction unit 15 outputs, to the target recognition unit 13, a signal obtained by performing the enhancement processing and noise reduction processing described above on the output signal TS2 as an output signal JS2. The target recognition unit 13 acquires the identification result CR of the target TG included in the candidate image CG, based on the candidate velocity CV, the candidate image CG, and the output signal JS2.

The present modification example is capable of improving accuracy of the recognition result NK of the target TG along with the improvement in accuracy of the identification result KR and the identification result CR obtained by the target recognition unit 13. The present modification example is therefore capable of robustly recognizing the target TG while securing the recognition accuracy of the target TG.

### Second Modification Example

The target recognition unit 13 may, for example, acquire the identification result KR of the target TG included in the observation image KG, based on the observation velocity KV, the observation image KG, and the transmission wave signal SS. Alternatively, the target recognition unit 13 may acquire the identification result KR of the target TG included in the observation image KG, based on the observation velocity KV, the observation image KG, and the reflected wave signal RS. The target recognition unit 13 may, for example, acquire the identification result CR of the target TG included in the candidate image CG, based on the candidate velocity CV, the candidate image CG, and the transmission wave signal SS. Alternatively, the target recognition unit 13 may, for example, acquire the identification result CR of the target TG included in the candidate image CG, based on the candidate velocity CV, the candidate image CG, and the reflected wave signal RS.

The present modification example is capable of improving accuracy of the recognition result NK of the target TG along with the improvement in accuracy of the identification result KR and the identification result CR obtained by the target recognition unit 13. The present modification example is therefore capable of robustly recognizing the target TG while securing the recognition accuracy of the target TG.

### Third Modification Example

The recognition result output unit 14 may output, for example, the observation image KG and the candidate image CG as information indicating basis of the recognition result NK, in addition to the recognition result NK.

The present modification example is capable of causing the display device 116 to display the class of the target TG, the observation image KG, and the candidate image CG. That is, the present modification example is capable of presenting the observation image KG and the candidate image CG to the user as information that can be used for evaluating validity of the class of the target TG included in the recognition result NK.

### Fourth Modification Example

The signal reconstruction unit 12 may, for example, generate multiple multiband images KM in accordance with the transmission wave signal SS and the observation velocity KV as the observation images KG. The multiple multiband images KM can be used when processing for acquiring the identification result KR is performed in the target recognition unit 13, together with the observation velocity KV and the observation image KG.

The signal reconstruction unit 12 may, for example, generate multiple multiband images CM in accordance with the transmission wave signal SS and the candidate velocity CV as the candidate images CG. The multiple multiband images CM can be used when processing for acquiring the identification result CR is performed in the target recognition unit 13, together with the candidate velocity CV and the candidate image CG.

The present modification example is capable of improving accuracy of the recognition result NK of the target TG along with the improvement in accuracy of the identification result KR and the identification result CR obtained by the target recognition unit 13. The present modification example is therefore capable of robustly recognizing the target TG while securing the recognition accuracy of the target TG.

### SECOND EXAMPLE EMBODIMENT

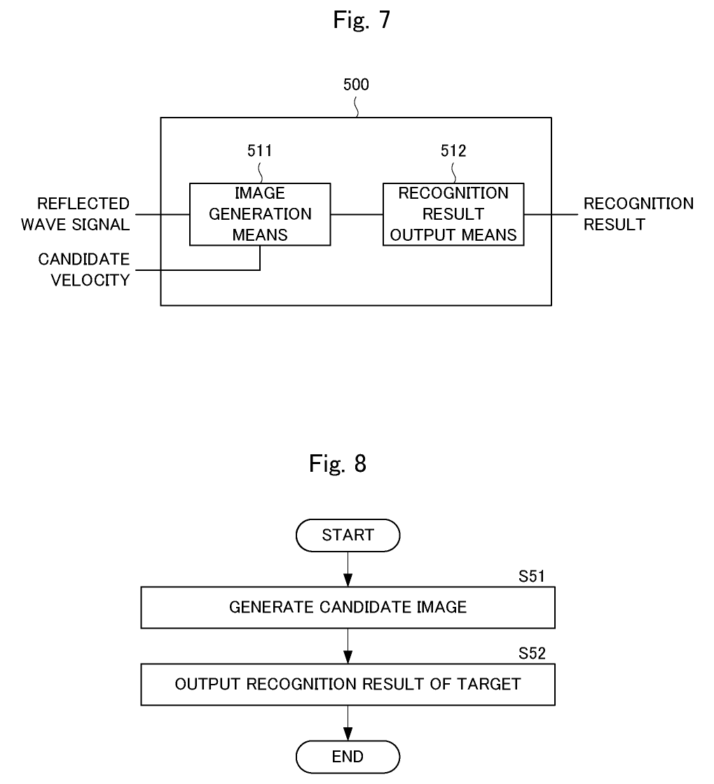

FIG. 7 is a block diagram illustrating an example of a functional configuration of an object recognition apparatus according to the present disclosure.

An object recognition apparatus 500 has a hardware configuration similar to that of the information processing device 100. The object recognition apparatus 500 includes an image generation means 511 and a recognition result output means 512.

The image generation means 511 can be achieved by using, for example, a function included in the signal reconstruction unit 12. The recognition result output means 512 can be achieved by using, for example, a function included in the recognition result output unit 14.

FIG. 8 is a flowchart illustrating an example of processing performed in the object recognition apparatus according to the present disclosure.

The image generation means 511 generates a candidate image corresponding to a candidate velocity, based on a candidate velocity equivalent to a velocity obtained by changing an observation velocity of a target observed by a radar device within a predetermined range and a reflected wave signal having a waveform corresponding to a reflected wave generated by reflection of a transmission wave emitted from the radar device by the target (step S51).

The recognition result output means 512 outputs a recognition result of the target based on a first identification result of the target included in the candidate image (step S52).

The present example embodiment is capable of securing recognition accuracy of the target observed by the radar device.

Some or all of the above example embodiments may also be described as the following Supplementary Notes, but are not limited to the following.

### Supplementary note 1

An object recognition apparatus comprising:

an image generation means configured to generate a candidate image corresponding to a candidate velocity, based on the candidate velocity equivalent to a velocity obtained by changing an observation velocity of a target observed by a radar device within a predetermined range and a reflected wave signal having a waveform corresponding to a reflected wave generated by reflection of a transmission wave emitted from the radar device by the target; and

a recognition result output means configured to output a recognition result of the target based on a first identification result of the target included in the candidate image.

### Supplementary note 2

The object recognition apparatus according to Supplementary note 1,

wherein the image generation means further generates an observation image corresponding to the observation velocity based on the observation velocity and the reflected wave signal, and

wherein the recognition result output means outputs information including a class of the target acquired, as the recognition result of the target, based on the first identification result and a second identification result included in the observation image.

### Supplementary note 3

The object recognition apparatus according to Supplementary note 2, further comprising a target recognition means configured to acquire the first identification result based on the candidate velocity and the candidate image, and acquire the second identification result based on the observation velocity and the observation image.

### Supplementary note 4

The object recognition apparatus according to Supplementary note 3, further comprising a signal extraction means configured to extract a first intermediate signal indicating an intermediate output in a process of generating the candidate image from the reflected wave signal, extract a second intermediate signal indicating an intermediate output in a process of generating the observation image from the reflected wave signal, and emphasize an important portion of the first intermediate signal and the second intermediate signal, wherein the target recognition means acquires the first identification result based on the candidate velocity, the candidate image, and the first intermediate signal, and acquires the second identification result based on the observation velocity, the observation image, and the second intermediate signal.

### Supplementary note 5

The object recognition apparatus according to Supplementary note 4, wherein the signal extraction means extracts, as the first intermediate signal, an output signal obtained by performing range compression processing on the reflected wave signal using the candidate velocity, and extracts, as the second intermediate signal, an output signal obtained by performing range compression processing on the reflected wave signal using the observation velocity.

### Supplementary note 6

The object recognition apparatus according to Supplementary note 3, wherein the target recognition means acquires the first identification result based on the candidate velocity, the candidate image, and a transmission wave signal having a waveform corresponding to the transmission wave, and acquires the second identification result based on the observation velocity, the observation image, and the transmission wave signal.

### Supplementary note 7

The object recognition apparatus according to Supplementary note 3, wherein the target recognition means acquires the first identification result based on the candidate velocity, the candidate image, and the reflected wave signal, and acquires the second identification result based on the observation velocity, the observation image, and the reflected wave signal.

### Supplementary note 8

The object recognition apparatus according to Supplementary note 2, wherein the recognition result output means outputs the observation image and the candidate image as information indicating basis of the recognition result, in addition to the recognition result.

### Supplementary note 9

An object recognition method executed by a computer, comprising: generating a candidate image corresponding to a candidate velocity, based on the candidate velocity equivalent to a velocity obtained by changing an observation velocity of a target observed by a radar device within a predetermined range and a reflected wave signal having a waveform corresponding to a reflected wave generated by reflection of a transmission wave emitted from the radar device by the target; and outputting a recognition result of the target based on a first identification result of the target included in the candidate image.

### Supplementary note 10

A recording medium recording program for causing a computer to perform processing comprising: generating a candidate image corresponding to a candidate velocity, based on the candidate velocity equivalent to a velocity obtained by changing an observation velocity of a target observed by a radar device within a predetermined range and a reflected wave signal having a waveform corresponding to a reflected wave generated by reflection of a transmission wave emitted from the radar device by the target; and outputting a recognition result of the target based on a first identification result of the target included in the candidate image.

While the present disclosure has been particularly described with reference to the example embodiments, the present disclosure is not limited to these example embodiments and examples. Various modifications that can be understood by those skilled in the art can be made to the configurations and details of the present disclosure within the scope of the present disclosure. And each example embodiment can be appropriately combined with other example embodiments.

### DESCRIPTION OF SYMBOLS

11 Velocity perturbation unit

12 Signal reconstruction unit

13 Target recognition unit

14 Recognition result output unit

50 Radar device

100 Information processing device

1. An object recognition apparatus comprising:
a memory configured to store instructions; and
one or more processors configured to execute the instructions to:
generate a candidate image corresponding to a candidate velocity, based on the candidate velocity equivalent to a velocity obtained by changing an observation velocity of a target observed by a radar device within a predetermined range and a reflected wave signal having a waveform corresponding to a reflected wave generated by reflection of a transmission wave emitted from the radar device by the target; and
output a recognition result of the target based on a first identification result of the target included in the candidate image.

2. The object recognition apparatus according to claim 1,
wherein the one or more processors further generate an observation image corresponding to the observation velocity based on the observation velocity and the reflected wave signal, and
wherein the one or more processors output information including a class of the target acquired, as the recognition result of the target, based on the first identification result and a second identification result included in the observation image.

3. The object recognition apparatus according to claim 2,
wherein the one or more processors are further configured to execute the instructions to acquire the first identification result based on the candidate velocity and the candidate image, and acquire the second identification result based on the observation velocity and the observation image.

4. The object recognition apparatus according to claim 3,
wherein the one or more processors are further configured to execute the instruction to extract a first intermediate signal indicating an intermediate output in a process of generating the candidate image from the reflected wave signal, extract a second intermediate signal indicating an intermediate output in a process of generating the observation image from the reflected wave signal, and emphasize an important portion of the first intermediate signal and the second intermediate signal,
wherein the one or more processors acquire the first identification result based on the candidate velocity, the candidate image, and the first intermediate signal, and acquires the second identification result based on the observation velocity, the observation image, and the second intermediate signal.

5. The object recognition apparatus according to claim 4, wherein the one or more processors extract, as the first intermediate signal, an output signal obtained by performing range compression processing on the reflected wave signal using the candidate velocity, and extract, as the second intermediate signal, an output signal obtained by performing range compression processing on the reflected wave signal using the observation velocity.

6. The object recognition apparatus according to claim 3, wherein the one or more processors acquire the first identification result based on the candidate velocity, the candidate image, and a transmission wave signal having a waveform corresponding to the transmission wave, and acquire the second identification result based on the observation velocity, the observation image, and the transmission wave signal.

7. The object recognition apparatus according to claim 3, wherein the one or more processors acquire the first identification result based on the candidate velocity, the candidate image, and the reflected wave signal, and acquire the second identification result based on the observation velocity, the observation image, and the reflected wave signal.

8. The object recognition apparatus according to claim 2, wherein the one or more processors output the observation image and the candidate image as information indicating basis of the recognition result, in addition to the recognition result.

9. An object recognition method executed by a computer, comprising:
generating a candidate image corresponding to a candidate velocity, based on the candidate velocity equivalent to a velocity obtained by changing an observation velocity of a target observed by a radar device within a predetermined range and a reflected wave signal having a waveform corresponding to a reflected wave generated by reflection of a transmission wave emitted from the radar device by the target; and
outputting a recognition result of the target based on a first identification result of the target included in the candidate image.

10. A non-transitory computer-readable recording medium storing a program, the program causing a computer to perform processing comprising:
generating a candidate image corresponding to a candidate velocity, based on the candidate velocity equivalent to a velocity obtained by changing an observation velocity of a target observed by a radar device within a predetermined range and a reflected wave signal having a waveform corresponding to a reflected wave generated by reflection of a transmission wave emitted from the radar device by the target; and
outputting a recognition result of the target based on a first identification result of the target included in the candidate image.
